(19) United States
(12) Patent Application Publication
(10) Pub. No.: US 2013/0066568 A1
(43) Pub. Date: Mar. 14, 2013

(54) INTEGRATED SYSTEM WITH ACOUSTIC TECHNOLOGY, MASS IMBALANCE AND NEURAL NETWORK FOR DETECTING, LOCATING AND QUANTIFYING LEAKS IN DUCTS

(71) Applicant: Julio Roberto Alonso, Sao Carlos (BR)

(72) Inventor: Julio Roberto Alonso, Sao Carlos (BR)

(21) Appl. No.: 13/639,868

(22) PCT Filed: Apr. 12, 2011
(86) PCT No.: PCT/BR2011/000107

§ 371 Date: Nov. 23, 2012

(30) Foreign Application Priority Data
Apr. 15, 2010 (BR) PI1002159-0

(51) Int. Cl. G01M 3/00; G06F 19/00

(52) U.S. Cl. 702/51

(57) ABSTRACT

The invention here presented regards to an integrated leak detection system which combines the acoustic technology with mass balance technology using artificial neural networks to achieve leak location, quantification provided with pressure sensors installed in strategic points along the pipeline, which act as acoustic sensors or sonic sensors; remotes units denominated FPU (Field Processing Unit); analog and digital filters; artificial neural networks (ANN); and, center monitoring station responsible for gathering and processing system information, using artificial neural networks algorithms that process also signals from the mass balance CFD (Computacional Fluid Dynamics) based on flow temperature pressure and density readings, to allow process parameter actualization in real time such as fluid density, acoustic wave propagation speed, flow speed and signal attenuation coefficient.

### INVENTION FIELD

The leak detection, location and quantification system proposed is implemented using a combination of two technologies, the acoustic technology and the mass balance technology. These two technologies have complementary operation characteristics resulting in several advantages from their integration, mainly because the two of them incorporate artificial neural networks (ANN), which in the occurrence of a leak event will provide alarm validation and identification for its presentation on the operation screen. Besides the alarm indication, the invention provide the correct location of the leak and also quantify the leaked volume, in addition to anticipating information and alerts to the user, even before alarm thresholds being reached.

The system provides a robust and reliable solution that besides allowing rapid detection, location and quantification even in preexisting or progressive leaks, provides the correct location and quantification of the leak, preventing product loss, environmental damage and practically eliminating false leak alarms.

### STATE OF THE ART

The acoustic technology is already known in the literature of pipeline leak detection and is based on the detection of the hydraulic transients generated at the onset of a leak, that propagate through the media reaching long distances. Several patents employ the use of acoustic technology, among which can be mentioned the U.S. Pat. No. 5,416,724, U.S. Pat. No. 5,623,421, U.S. Pat. No. 5,625,150, U.S. Pat. No. 5,675,506 and U.S. Pat. No. 6,567,795 and PI0705728-8.

Among the patents listed above, the document PI0705728-8 is highlighted, because it has the same owner of the system herein claimed, and in general, describes an acoustic technology system and artificial neural network (ANN) to detect leak signals in pipelines.

The said leak detection is made with the use of special pressure sensors installed at strategic points along the pipeline, which act as acoustic or sonic sensors. The signals captured by the sensors are read and processed locally by remote units called Field Processing Units—FPU, responsible for locally process the signals using various techniques, different types of analog and digital filters and through artificial neural networks (ANN), being that the FPUs units transmit the processed signals to the Central Monitoring Station (CMS) and, in the case of an leak event, an alarm is announced in the CMS operation screen.

The system described in PI0705728-8 is very effective for leak detection and location, but it has no leak quantification. The mass balance technology, or compensated volume balance, is also known in the art of pipeline leak detection. For example, the document U.S. Pat. No. 4,308,746 describes various equations known in the literature, which are used to detect leaks from measurements of variables in the pipeline. It is worth mentioning that the mass balance technology performs partially ineffective for detecting leaks in pipelines, considering that does not guarantee the accuracy and speed required for detection and location of said leak.

### INVENTION PURPOSE

The invention proposed herein aims to integrate the mass balance, acoustics and artificial neural network technologies, for detection, localization and quantification of leaks or holes in pipelines.

### INVENTION ADVANTAGES

The invention provides a precise leak location and quantifies the product leaked from the pipeline.
The information from the two modules are crossed, before making decisions and issuing alarm to the user.
The combination of the mass balance, artificial neural network (ANN) and acoustic technologies offers a significant gain in system reliability by substantially reducing the number of occurrences of false alarms.

### DRAWINGS DESCRIPTION

FIG. 1 illustrates the detection, location and quantification algorithm and the overall acoustic and mass balance integrated technologies system architecture. The main modules are shown by blocks.

FIG. 2 illustrates the detection, location and quantification obtained by the mass balance module of the invention and their algorithms without integration with the acoustic system.

FIG. 3 illustrates an implementation example of the bar chart of the detection, location and quantification system.

### INVENTION DESCRIPTION

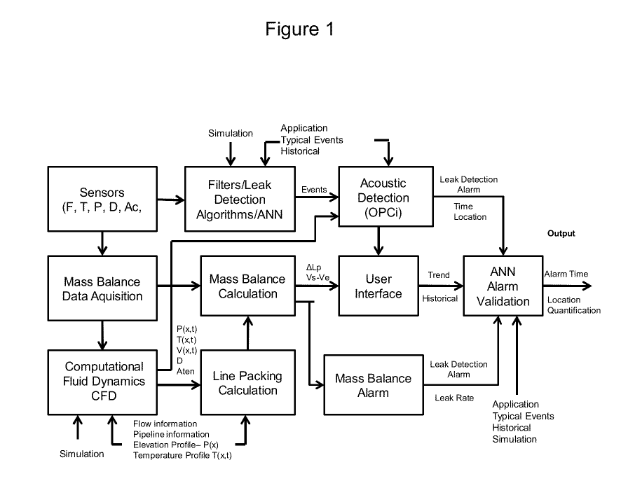

The leak detection system based on acoustic principle, represented by the three upper blocks in FIG. 1, operates in the same manner provided in PI0705728-8. That is, the detection of signals is performed with use of special pressure sensors installed at strategic points along the pipeline, which act as acoustic or sonic sensors. The sensor signals are read by remote units called Field Processing Units—FPU, which process the signals locally using various techniques, different types of analog and digital filters and through artificial neural networks (ANN). The FPU units transmit the processed signals to the CMS where the system information are combined and processed, using algorithms based on neural networks and in case of occurrence of a leak, the alarm will be presented in the operation screen indicating its correct location, added that in the proposed invention the system also receives signals from the Mass Balance System CFD for update, in real time, some process related data such as flow rate, fluid density, acoustic wave propagation velocity in the fluid, flow velocity and signal attenuation coefficient. The possibility to update these data in real time provides an improvement in the acoustic system performance, for example, minimizing the location errors due to changes in the flow, which is one of the advantages arising from the integration of the two technologies.

In the final alarms validation process, the last block on the right in FIG. 1, information from the two systems is used for a cross check before making decisions and issuing the alarm for the user. This combination offers a significant gain in system reliability by substantially reducing the number of occurrences of false alarms.

In terms of hardware, there are also advantages resulting from the coexistence of both systems. One can, for example, connect the mass balance sensors to the inputs of the acoustic system remote units, transmitting the data via the FPU local network. In some cases it is even possible to share the functions of acoustic sensors with the mass balance system allowing more of pressure measurement points further along the pipeline. Additional measurement points enhance the mass balance algorithms performance, allowing better CFD module modeling.

The acoustic detection algorithms present in the invention also exhibit greatly improved performance with the use of artificial neural networks (ANN), which are trained to recognize leak patterns of each specific application. This implementation by itself contributes to the false alarms occurrence reduction, thus greatly improving the reliability of the acoustic system.

It is also possible to electronically simulate leakage through filters excitation, which allows rapid evaluation of the responses of the entire acoustic system.

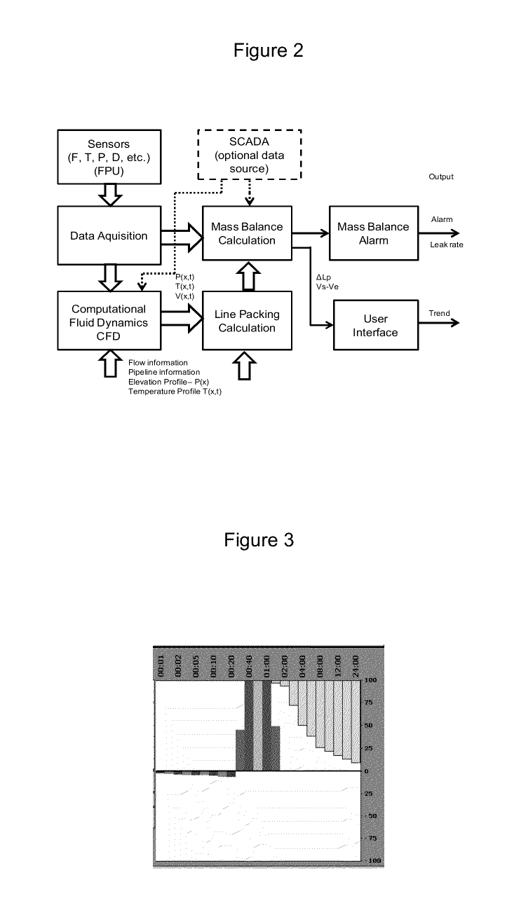

The mass balance detection, localization and quantification system of the invention can be seen in FIG. 2, without the acoustic system integration.

The mass balance technology, or compensated volume balance used in the invention has a special implementation, facilitating the integration of the two systems.

The signals that allow the cyclic mass balance calculation are obtained from flow, pressure, temperature and density meters, installed at the ends of the pipeline section to be protected. It is possible to use the existing plant instrumentation, in this case obtaining data through SCADA (System control and data Acquisition).

In the Central Monitoring Station information from the two systems are combined and processed, including the use of neural network alarm validation.

The Central Monitoring is based on a PC-type computer equipped with a OPCi driver, acoustic and mass balance detection modules (proprietary), and a supervisory system that works as Human Machine Interface (HMI) for all system operation as input parameters and other functions. The information and HMI functions can be replicated to other locations via OPC communication.

The mass balance system comprises essentially the following modules and algorithms:

a) Input Data Acquisition and Validation Module

The acquisition and data validation module main function is to ensure correct and reliable field data acquisition. In this module is included tools for data consistency checking and validation as well as some handlers for partial loss, corrupted data, and out of range values.

In new facilities, were there is no instrumentation present, the necessary instruments for the mass balance operation, such as flow, pressure, temperature and density meters, can be connected to the acoustic system remote units (FPU) inputs, transmitting data to the central through the FPUs communication network.

In cases where instrumentation for measuring flow, pressure and temperature is already present, the data necessary for operation of the invention can be obtained directly from the SCADA system of the plant, only by making the needed conversions and scale adjustments. In these cases data acquisition routines, somewhat more simplified, are provided also in the computational modules for SCADA data acquisition. Both implementations appear illustrated in FIG. 2.

b) Flow Modeling Including the Transient Regimen, Using Computational Fluid Dynamics (CFD) Algorithms from the Input Data

The CFD module included in the Mass Balance Algorithm is based on thermal-fluid dynamics classical equations and it is used for:
Thermo-fluid dynamic modeling capable of reconstructing in real time, pressure, temperature and velocity profiles including transient regimen using punctual measurements of pressure, flow and temperature;
Computing pressure, temperature and velocity profile along the pipeline;
Line Packing calculation including transient regimen and correction of variance caused by influences of temperature and pressure on the fluid and on the pipeline steel, according to standards API-1149 e API-11.1;
Compensation of the influence of the vertical profile on the pipeline (dimension×position);
Compensation of thermal exchanges with the environment;
Data input of fluid characteristics such as density, viscosity, compressibility, heat capacity, and others, according to the API publications;
Data input of pipeline characteristics such as section length, outer diameter, wall thickness, material, expansion coefficient, coating layers, thermal parameters, etc.;
Input for pipeline elevation profile (table: height×position), control valves and pump mapping, etc.
Data input of environment temperature profile along the pipeline and their thermal parameters according to different kinds of installation (underwater, aerial, underground, etc.).
Calculation of acoustic velocity profile (mechanic wave propagation) along the pipeline and of other important variables used to improve acoustic leak detection; and,
Virtual leak simulation tool and system tests (off-line);

The calculations are done in real time by updating the readings at each sampling received data

The calculation of velocity, temperature and pressure profiles provided by the CFD is properly corrected for compensation of influences of the elevation profile (height variation×position), temperature profile, heat exchange along the pipeline, and other interferences.

All necessary variables and parameters are reported to the module via the HMI (Human Machine Interface).

c) Line Packing Calculation Algorithm in Transient Regime

The calculation of the line packing (instantaneous pipeline volume) is done based on the velocity, temperature and pressure profiles provided by CFD (FIGS. 1 and 2). The calculation of the line packing is updated with every sample received and is used as one of the inputs to the calculation of the mass balance in the corresponding module.

Because it is calculated based on estimated values and data from models, due to the unavailability of real data along the pipeline, the line packing is always subject to uncertainties of greater magnitude and is therefore the most critical component in the calculation of the mass balance.

d) Algorithm for Calculating the Mass Balance or Compensated Volume Balance

The module for calculating the Mass Balance works together with the data acquisition module, the CFD and line packing, performing the following main tasks:
Calculation of mass balance and compensated volume balance, obtained from measurements of mass or volume;
Outputs for Graphical User Interface (GUI) and plotting line behaviors or state chart (Line Packing Variation×Difference of Input and Output Flows).
Provide data output and mass balance calculation results to the alarms generation module.
Quantification of leaks;
Detecting leaks about 5% of the normal flow rate of the pipeline, without the occurrence of false alarms; and
Support tools of system virtual tests with simulated leaks (off-line);

e) Graphical Interface for Viewing Line Behavior (Evolution of Line Packing×I/O Flow Rate Difference)

The behavior of the line can watched from a state chart, available in GUI system which allows viewing the behavior of the pipeline, or through a bar graph showing the difference between the input and output flow rates.

The state graph is plotted using information on the evolution of the line packing and differences in measurements of input and output flow rates, allowing visualization of characteristic behavior of the pipeline operation. The graph behavior makes possible the interpretation of various situations in normal operation of the line, facilitating the rapid identification of trends and abnormal situations that may be indicative of leaks, even before issuing the alarm.

The bar graph shows the differences between the corrected inlet and outlet flow rate, totalized in 12 different time intervals from 1 minute to 24 hours, changing color when the pre-defined thresholds are exceeded. In FIG. 3 is shown an example implementation of the bar graph

f) Alarm Generation Module

The alarm generation algorithm works strictly connected to the mass balance module, continuously monitoring the deviations from the normal operating ranges. The module allows the automatic generation of alarms when deviations exceed the thresholds pre-defined by the user of the system. In alarm situations this module also calculates the leak rate, which will be used for the quantification of spilled volume, together with the time information of the alarm and location of leakage from the acoustic module.

The outputs of this module are also checked by the alarm validation module before issuing the warning to the user.

g) Trend Analysis Algorithm and Alarm Validation Based on Artificial Neural Network (ANN)

Since the acoustic system and mass balance have mutually complementary features, the ability to have a more complete understanding of the scenario associated with the operation of the pipeline, based on data and information from the two systems, is a unique advantage of the invention, not being afforded by any other leak detection technology. In addition to greater reliability of the information generated, especially the alarms, the invention combines quick answers with the richest set of information about the spill, being able to determine the time and place where the leak has occurred, the flow and totalized volume of spilled product, as well as trends and other information that facilitate the decision process.

The alarms validation and trend analysis module uses special algorithms based on artificial neural networks (ANN) which allow to effectively interpret and identify the leak situations among the various situations generated under normal pipeline operation. In cases of abnormal situations, such as leakage, this unique feature of the invention allows to provide information and alerts to the user, even before they reached the thresholds for issuing alarms.

Before sending the alarm to the user, alarm signals received by the module are checked crossing over information from the two systems and a qualitative analysis of trends and other variables, such as graphic behavior. If everything is consistent with a leak situation then the alarm will be issued, along with all available information such as the time of occurrence, location of the leak, leak rate, total volume spilled and trends.

All this information is available on the HMI system.

h) Human Machine Interface (HMI) for Monitoring System, Data Input, Etc.

The user interfaces provided in this invention provide all the resources needed for easy operation of the system as input data, configurations, etc., as follows:
Window for data entry of fluid characteristics such as density, viscosity, compressibility, heat capacity and other information, according to the API publications;
Window for data entry of features of the pipeline such as the section length, external diameter, wall thickness, material, expansion coefficient, coating layers, heat capacity, and others;
Window for setting the pipeline elevation profile, altimetric and bathymetric. (table: height×position);
Window for setting the temperature profile along the pipeline and thermal parameters of each section according to the type of installation (underwater, aerial, underground, etc.).
Animated plotting of line behavior (Delta Flow Rate×Delta LP) with neural network analysis;
Operation Screen with bar graph with 12 different integration times (1 minute to 24 hours).
Generating historical easily retrievable, with user-friendly interface;
Screen containing simulation and system testing;
Access controlled by passwords with different users levels;
Driver for communication with generic HMI (Intouch, iFIX, etc.), via OPC;

1. INTEGRATED SYSTEM FOR DETECTION, LOCATION AND QUANTIFICATION OF LEAKS IN PIPELINES, using the acoustic technology, mass balance and artificial neural network (ANN), and in a event of a leak, even in preexisting or progressives leaks, permits the alarm identification and validation for its statement in the operation screen, as well as, identifies the leak location and quantifies the spilled volume, besides anticipating information and alerts to the user, even before the thresholds for issuing alarms are reached, eliminating the occurrence of false leak alarms, where the system is endowed of: pressure sensors installed at strategic points along the pipeline, that act as acoustic or sonic sensors; remote units called FPU (Field Processing Units); analog and digital filters; Artificial neural networks (ANN); and, Central Monitoring Station (CMS) where the system information are combined and processed, characterized by the use of Acoustics and Mass Balance technology information to cross-check, before taking any decisions and issuing an alarm to the user, using algorithms based on neural networks, being that this system allows electronic simulation of leaks through the excitation of its internal filters.

2. INTEGRATED SYSTEM FOR DETECTION, LOCATION AND QUANTIFICATION OF LEAKS IN PIPELINES, according to the claim 1, characterized by allowing the connection of sensors that belong to the mass balance system to the remote units inputs of the acoustic system, transmitting data over the FPU's local network.

3. INTEGRATED SYSTEM FOR DETECTION, LOCATION AND QUANTIFICATION OF LEAKS IN PIPELINES, according to the claim 1, characterized by allowing the sharing of the acoustic sensors functions to the Mass Balance system, allowing the obtaining of additional pressure measuring points along the line and thus propitiates the nearest modeling profile by the CFD module.

4. INTEGRATED SYSTEM FOR DETECTION, LOCATION AND QUANTIFICATION OF LEAKS IN PIPELINES, according to the claim 1, characterized by signals that enable the Mass Balance cyclic calculations to be obtained from flow, pressure, temperature and density meters, installed at the ends of the protected section, which are connected to the remote units inputs (FPU) of the acoustic system, transmitting data to the central via FPUs communication network.

5. INTEGRATED SYSTEM FOR DETECTION, LOCATION AND QUANTIFICATION OF LEAKS IN PIPELINES, according to the claim 1, characterized by allowing the use of existing instrumentation in the plant, obtaining data through SCADA (system control and data acquisition).

6. INTEGRATED SYSTEM FOR DETECTION, LOCATION AND QUANTIFICATION OF LEAKS IN PIPELINES, according to the claim 1, characterized by Central Monitoring Station that is based on a PC-type computer equipped with an OPCi driver, acoustic and mass balance detection modules, and a supervisory system which works as Human Machine Interface (HMI) to operate the entire system and parameters input.

7. INTEGRATED SYSTEM FOR DETECTION, LOCATION AND QUANTIFICATION OF LEAKS IN PIPELINES, according to the claim 1, characterized by the information and HMI functions that can be replicated to other locations via OPC communication.

8. INTEGRATED SYSTEM FOR DETECTION, LOCATION AND QUANTIFICATION OF LEAKS IN PIPELINES, according to the claim 1, characterized by mass balance system essentially comprise the following modules and algorithms: a) Acquisition module and validation of input data; b) CFD algorithms (Computational Fluid Dynamics) for flow modeling, including the transient regimen, from data input; c) Line packing calculation algorithm in transient regimen; d) Algorithm for calculating the mass balance or compensated volume balance; e) Graphical interface for line behavior viewing (line-packing evolution×I/O flow differences); f) Generation alarms module; g) Trend analysis and alarms validation algorithm based on artificial neural networks (ANN); and, h) User interface (HMI) for system monitoring and data entry.

9. INTEGRATED SYSTEM FOR DETECTION, LOCATION AND QUANTIFICATION OF LEAKS IN PIPELINES, according to the claim 1, characterized by the acquisition module and the input data validation tools for checking the coherency of data and validation of them, as well as some treatment routines for the cases of partial loss of data, corrupted data and out of range values.

10. INTEGRATED SYSTEM FOR DETECTION, LOCATION AND QUANTIFICATION OF LEAKS IN PIPELINES, according to the claim 1, Characterized by CFD algorithms (Computational Fluid Dynamics) for flow modeling, including transient regime, from the input data and perform the following functions:
Thermo-fluid dynamic modeling (CFD) capable of reconstructing in real time, the pressure transients, temperature and velocity profiles, from punctual measurements of pressure, flow and temperature;
Calculating the profiles of pressure, temperature and velocity throughout the section length;
Calculating the line-packing in transient regimen with correction of temperature and pressure influences on the fluid and pipeline steel, according to standards API-1149 and API-11.1;
Compensation of influence of the pipeline's vertical profile (dimension×position);
Compensation of thermal exchanges with the environment;
Data input and fluid characteristics such as density, viscosity, compressibility, heat capacity, and others, according to API publications;
Data input and pipeline features such as section length, external diameter, wall thickness, material, expansion coefficient, coating layers, thermal parameters, and other;
Input for configuration of the pipeline elevation profile (table: vertical quota×position), mapping of control valves, pumps, etc;
Data input of ambient temperature (profile) along the pipeline and respective thermal parameters of each section according to the type of installation (underwater, aerial, underground, etc.);
Calculation of acoustic velocity profile (propagation of mechanical waves) along the section, and other important variables to optimize the acoustic method detection; and,
Tool for virtual leaks simulation and system testing (off-line).

11. INTEGRATED SYSTEM FOR DETECTION, LOCATION AND QUANTIFICATION OF LEAKS IN PIPELINES, according to the claim 10, Characterized by CFD algorithms (Computational Fluid Dynamics) for flow modeling, including transient regimen, to perform calculations in real time from the input data, updating the readings at each sampling of received data.

12. INTEGRATED SYSTEM FOR DETECTION, LOCATION AND QUANTIFICATION OF LEAKS IN PIPELINES, according to the claim 11, Characterized by CFD algorithms (Computational Fluid Dynamics) for flow modeling, including transient regimen, from the input data the velocity, temperature and pressure profiles provided by the CFD are calculated being duly corrected to compensate the influence of the pipeline elevation profile (vertical quota variation×position), ambient temperature profile along the pipeline, different thermal exchanges along the section, and other interferences, and all the variables and parameters necessary to perform the corrections are reported to the module via HMI (Human Machine Interface).

13. INTEGRATED SYSTEM FOR DETECTION, LOCATION AND QUANTIFICATION OF LEAKS IN PIPELINES, according to the claim 1, characterized by the line packing calculation (instantaneous volume contained in the monitored section), be done based on the velocity, temperature and pressure profiles provided by the CFD (FIGS. 1 and 2), is updated at every received sample and it is used as one of the inputs to perform the calculation of the mass balance in the corresponding module.

14. INTEGRATED SYSTEM FOR DETECTION, LOCATION AND QUANTIFICATION OF LEAKS IN PIPELINES, according to the claim 13, characterized by calculation of line packaging based on estimated values and data from models.

15. INTEGRATED SYSTEM FOR DETECTION, LOCATION AND QUANTIFICATION OF LEAKS IN PIPELINES, according to the claim 1, characterized by the algorithm used to calculate the mass balance or compensated volume balance, works in conjunction with the data acquisition modules, CFD and Line packing, performing the following main tasks:
Calculate the mass balance or compensated volume balance, obtained from massic or volumetric measurements;
Outputs for graphical interface and plotting line behavior, or state chart (Line packing variations×flows rates difference between input and output);
Provide data outputs and mass balance calculations results for the alarm generation module;
Leak quantification;
Leak detection on the order of or equal to 5% of the normal pipeline flow rate; and,
Support for the tools of virtual test with leaks simulation (offline).

16. INTEGRATED SYSTEM FOR DETECTION, LOCATION AND QUANTIFICATION OF LEAKS IN PIPELINES, according to the claim 1, characterized by a graphical interface for line behavior viewing (line-packing evolution×I/O flow rate differences), to observe the line behavior from a state chart, available on the system graphical interface, it is plotted from the evolution of the line-packing and from the measure of input and output flow rate differences, allowing the visualization of behavior and features of the pipeline operation.

17. INTEGRATED SYSTEM FOR DETECTION, LOCATION AND QUANTIFICATION OF LEAKS IN PIPELINES, according to the claim 16, characterized by a graphical interface for viewing behavior (line-packing evolution×I/O flow rate differences), to observe the line behavior done by means of a bar chart that shows the mass balance difference (differences between the inlet and outlet flow rate plus the line pack variation), showing the differences between the corrected inlet and outlet flow rate, totalized in 12 different time intervals from 1 minute to 24 hours, changing color when the defined thresholds are exceeded.

18. INTEGRATED SYSTEM FOR DETECTION, LOCATION AND QUANTIFICATION OF LEAKS IN PIPELINES, according to the claim 1, characterized by the alarms generation algorithm operates strictly connected to the mass balance module, continuously monitoring the deviations from the normal operating ranges, allowing the automatic alarms generation whenever deviations exceed the thresholds defined by the system user.

19. INTEGRATED SYSTEM FOR DETECTION, LOCATION AND QUANTIFICATION OF LEAKS IN PIPELINES, according to the claim 18, characterized by the alarms generation algorithm calculates the leak rate, which will be used to quantify the spilled volume, in conjunction with the alarm time information and leak location, provided by the acoustic module.

20. INTEGRATED SYSTEM FOR DETECTION, LOCATION AND QUANTIFICATION OF LEAKS IN PIPELINES, according to the claim 19, characterized by the outputs of the alarms generating module are also checked by the alarm validation module before issuing an alarm to the user.

21. INTEGRATED SYSTEM FOR DETECTION, LOCATION AND QUANTIFICATION OF LEAKS IN PIPELINES, according to the claim 1, characterized by the trend analysis algorithm and alarm validation be based on artificial neural networks (ANN) characterized by determining the time and place where the leak has occurred, the flow and totalized volume of the spilled product, as well as trends and other information that facilitate the making decisions process.

22. INTEGRATED SYSTEM FOR DETECTION, LOCATION AND QUANTIFICATION OF LEAKS IN PIPELINES, according to the claim 21, characterized by the trend analysis algorithm and alarm validation based on artificial neural networks (ANN), anticipate information and alerts to the user, even before the thresholds for alarms issuing are reached.

23. INTEGRATED SYSTEM FOR DETECTION, LOCATION AND QUANTIFICATION OF LEAKS IN PIPELINES, according to the claim 22, characterized by the trend analysis algorithm and alarm validation based on artificial neural networks (ANN), before validating the issuing the alarm to the user, check the received alarm signals, doing a crosscheck of information received from both systems and a qualitative analysis of trends and other variables, as the ones made by the behavior graphs, and that all this information is available on the system's HMI.

24. INTEGRATED SYSTEM FOR DETECTION, LOCATION AND QUANTIFICATION OF LEAKS IN PIPELINES, according to the claim 1, characterized by the user interface (HMI) for the system monitoring, data input, to provide resources needed to easy system operation as, data input, configuration, as follows:
Window for data input and fluid features such as, density, viscosity, compressibility, thermal coefficient and other information, according to API publications;
Window for data input and pipeline features such as, section length, external diameter, wall thickness, material, expansion coefficient, coating layers and thermal capacity;
Window for configuration of topographic (altimetric and bathymetric) profile (table: vertical quota×position);
Window for ambient temperature Input (profile) along the pipeline and thermal parameters of each section according to the type of installation (underwater, aerial and underground);
Animated plotting of behavior (Delta Vaz×Delta Lp) with diagnoses of neural network;
Operation screen with bar graph of 12 different integration times (1 minute to 24 hours);
Historical generation, with friendly interface;
Simulation screen and system tests;
Controlled access with passwords for different user levels; and,
Driver for communication with interface (HMI) generic (Intouch and iFIX), via OPC.
